(19) United States
(12) Patent Application Publication
(10) Pub. No.: US 2025/0347011 A1
(43) Pub. Date: Nov. 13, 2025

(54) BIMETALLIC RUTHENIUM-COBALT ALLOY ELECTROCATALYST FOR HYDROGEN PRODUCTION

(71) Applicant: KING FAHD UNIVERSITY OF PETROLEUM AND MINERALS, Dhahran (SA)

(72) Inventors: Muhammad Ali EHSAN, Dhahran (SA); Abuzar KHAN, Dhahran (SA); Abbas Saeed HAKEEM, Dhahran (SA)

(73) Assignee: KING FAHD UNIVERSITY OF PETROLEUM AND MINERALS, Dhahran (SA)

(21) Appl. No.: 18/658,287

(22) Filed: May 8, 2024

(51) Int. Cl. C25B 11/089; C25B 11/031; C25B 11/052; C25B 11/061

(52) U.S. Cl. CPC C25B 11/089; C25B 11/031; C25B 11/052; C25B 11/061

(57) ABSTRACT

An electrode includes a bimetallic ruthenium-cobalt (RuCo) alloy electrocatalyst having a metallic substrate and a layer of a RuCo alloy at least partially covering the surface of the metallic substrate. The layer of the RuCo alloy includes spherical-shaped particles having an average particle size of 0.5 to 5 micrometers (μm). The electrode can be used for electrochemical water splitting applications to generate hydrogen and water.

### BACKGROUND

### Technical Field

The present disclosure is directed towards green production of hydrogen, more particularly directed towards an electrode including a bimetallic ruthenium-cobalt (RuCo) alloy electrocatalyst for hydrogen production.

### Description of Related Art

The “background” description provided herein presents the context of the disclosure generally. The work of the presently named inventors, to the extent it is described in this background section, as well as aspects of the description that may not otherwise qualify as prior art at the time of filing, are neither expressly nor impliedly admitted as prior art against the present invention.

Clean hydrogen is a preferable solution to severe planetary crises of energy and environmental pollution. Hydrogen, as a fuel, has properties including, but not limited to, high energy density, pollution-free combustion, and sustainable supply; therefore, it is viewed as a potential replacement for conservative fossil energy resources. Despite these facts, the current industrial route of hydrogen production relies heavily on fossil fuels, which produce abundant CO₂ gas detrimental to the environment. Thus, substantial efforts have been made to explore cleaner, more sustainable, and energy-efficient routes of hydrogen production. Presently, non-fossil energy-based water electrolysis technology involving two half-reactions of hydrogen evolution reaction (HER) and oxygen evolution reaction (OER) is the most affordable and reliable solution for clean hydrogen generation [See: P. Hota, A. Das and D. K. Maiti, International Journal of Hydrogen Energy, 2023, 48, 523-541 and S. Wang, A. Lu and C.-J. Zhong, Nano Convergence, 2021,8, 1-23]. For scalable hydrogen production, it is vital to develop highly active and potent electrocatalyst to drive the HER at faster rates [See: J. Jayabharathi, B. Karthikeyan, B. Vishnu and S. Sriram, Physical Chemistry Chemical Physics, 2023 and B. A. Yusuf, W. Yaseen, M. Xie, R. S. Zayyan, A. I. Muhammad, R. Nankya, J. Xie and Y. Xu, Advances in Colloid and Interface Science, 2023, 311, 102811]. Principally, water electrolysis may be carried out in both acidic and alkaline conditions; however, acidic conditions are technologically and commercially non-viable due to the lack of appropriate and efficient counter-electrode material. Consequently, efforts have been focused on developing highly active and stable the HER catalysts for basic media to promote the commercialization of H₂ production [See: H. Jung, S. Choung and J. W. Han, Nanoscale Advances, 2021, 3, 6797-6826 and J. Wang, Y. Gao, H. Kong, J. Kim, S. Choi, F. Ciucci, Y. Hao, S. Yang, Z. Shao and J. Lim, Chemical Society Reviews, 2020, 49, 9154-9196]. Although the HER in an alkaline environment proceeds slowly, a large overpotential is required to make the HER efficient, making it an energy-intensive process. Therefore, designing efficient and robust catalysts for the alkaline HER process is a crucial and challenging task. Generally, the process of catalyzing water into hydrogen and oxygen initiates through the adsorption of hydrogen on the surface of the advanced catalyst to form metal-hydrogen (M—H) bonds [See: H. Li, Q. Tang, B. He and P. Yang, Journal of Materials Chemistry A, 2016, 4, 6513-6520]. In particular, platinum (Pt) has the potential to develop a Pt—H bond and perform HER catalysis. Adversely, Pt's high price and low availability make it less favorable for large-scale applications [See: J.-X. Feng, J.-Q. Wu, Y.-X. Tong and G.-R. Li, Journal of the American Chemical Society, 2018, 140, 610-617]. Further, a plurality of economical, efficient, and robust alternatives of Pt-based electrocatalysts workable in alkaline media have been explored for the HER catalysis [See: X. Cao, Y. Han, C. Gao, Y. Xu, X. Huang, M. Willander and N. Wang, Nano Energy, 2014, 9, 301-308 and D. Wu, W. Zhang, A. Lin and D. Cheng, ACS applied materials & interfaces, 2020, 12, 9600-9608].

Recently, ruthenium (Ru) based electrocatalysts have been studied due to their ability to form a Ru—H bond, similar to Pt catalysts. Further, Ru is more economical than Pt, more corrosion resistant than Pt, and has a high intrinsic catalytic value [See: P. Jiang, Y. Yang, R. Shi, G. Xia, J. Chen, J. Su and Q. Chen, Journal of Materials Chemistry A, 2017, 5, 5475-5485]. Recently, uniformly dispersed Ru nanoparticles on graphite nanoplates demonstrated better HER activity than benchmark Pt/C, although Ru has a strong affiliation with H atoms and subsequent deprotonation. An appropriate solution to this problem may be coupling Ru with other 3d transition metals, which may tune the strength of Ru—H interaction. Moreover, alloying Ru with earth-abundant transition metals may decrease the amount of required Ru metal to an order of magnitude; thus, cost-competitive, more efficient electrocatalysts may be synthesized for large-scale applications. Previous research demonstrates that bimetallic synergy between noble-transition metals may effectively boost electrocatalytic activities due to the shifting in charge distribution and modifications in structural properties during alloy formation. Therefore, variation in the compositions is another effective way to increase Ru's utilization efficiency.

Previously, RuCo alloy coupled with hollow carbon spheres (RuCo@HCSs) was fabricated through a wet vacuum impregnation followed by pyrolysis, showed promising the HER activities in different pH media (acidic, alkaline and neutral) [See: H. Wang, C. Gao, R. Li, Z. Peng, J. Yang, J. Gao, Y. Yang, S. Li, B. Li and Z. Liu, ACS Sustainable Chemistry & Engineering, 2019, 7, 18744-18752]. In another study, bimetallic RuCo nanoalloy encapsulated in nitrogen-doped graphene layers displayed remarkable performance with low overpotentials of only 28 and 218 mV at 10 and 100 mAcm⁻², respectively, and excellent stability of 10000 cycles. Similarly, three-dimensional nanoporous CuRu alloy and NiRu alloy wrapped in nitrogen-doped carbon have been reported as high-performance platinum-free catalysts for the HER in both alkaline electrolytes.

Traditionally, the synthesis of highly active and stable HER alloy catalysts is mainly achieved by pyrolysis of metal-organic frameworks (MOF) compounds. However, synthesizing MOFs is usually difficult and time-consuming, with low product yield. Besides, alloy catalysts obtained by MOF pyrolysis often lack elemental homogeneity and control over structural and morphological properties. Furthermore, large amounts of carbon are involved with desired alloy materials, which has been portrayed as enhancing the conductivity of the catalyst material.

Although several materials have been developed in the past for hydrogen production, there still exists a need to fabricate and explore bimetallic alloy electrocatalysts for more efficient hydrogen generation.

### SUMMARY

In an exemplary embodiment, an electrode including a bimetallic ruthenium-cobalt (RuCo) alloy electrocatalyst is described. The electrode includes a metallic substrate and a layer of a RuCo alloy at least partially covering the surface of the metallic substrate. The layer of the RuCo alloy includes spherical-shaped particles having an average particle size of 0.5 to 5 micrometers (μm).

In some embodiments, the asphaltenes include carbon, hydrogen, nitrogen, oxygen, sulfur, vanadium, and nickel.

In some embodiments, the spherical-shaped particles of the RuCo alloy have an average particle size of 1 to 3 μm.

In some embodiments, the spherical-shaped particles of the RuCo alloy are aggregated.

In some embodiments, the RuCo alloy includes about 25 to 36 weight percentage (wt. %) of Ru, and about 58 to 68 wt. % of Co, each wt. % based on a total weight of the RuCo alloy.

In some embodiments, the RuCo alloy includes about 31.2 wt. % of Ru, and about 63.4 wt. % of Co, each wt. % based on the total weight of the RuCo alloy.

In some embodiments, the metallic substrate is at least one metal foam selected from the group consisting of an aluminum foam, a nickel foam, a titanium foam, a titanium alloy foam, an aluminum alloy foam, a magnesium alloy foam, a nickel alloy foam, and a steel foam.

In some embodiments, the metallic substrate is a nickel foam.

In some embodiments, the electrode includes an overpotential of about 15 to 20 millivolts relative to the reversible hydrogen electrode (mV_{RHE}) at a current density of about 10 milliamperes per square centimeter (mA/cm²).

In some embodiments, the electrode includes an overpotential of about 80 to 120 mV_{RHE} at a current density of about 100 mA/cm².

In some embodiments, the electrode includes an overpotential of about 70 to 100 mV_{RHE} at a current density of about 50 mA/cm² for at least 24 hours (h).

In some embodiments, a Tafel slope of about 30 to 50 mV/decade.

In some embodiments, the electrode includes a charge transfer resistance (Rct) of about 1.6 to 2.2 ohms (Ω) as determined by electrochemical impedance spectroscopy (EIS).

In another exemplary embodiment, a method of making the electrode is described. The method includes mixing and dissolving a Ru salt, and a Co salt in a solvent to form a solution, aerosolizing the solution to form an aerosol, placing the metallic substrate in a heating chamber, and passing the aerosol through the heating chamber in the presence of a carrier gas. The metallic substrate is in direct contact with the aerosol. The method further includes heating the metallic substrate in the chamber at a temperature of about 450 to 500 degrees Celsius (° C.) to form the RuCo alloy on the surface of the metallic substrate, where at least a portion of the Ru salt and the Co salt present in the aerosol is decomposed to generate the RuCo alloy during heating.

In some embodiments, the solvent is at least one selected from a ketone solvent, an ester solvent, an alcohol solvent, an amide solvent, and an ether solvent.

In some embodiments, a molar ratio of the Ru salt to the Co salt present in the solution is in a range of 1:1 to 1:4.

In some embodiments, the Co salt includes cobalt acetylacetonate, cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or its hydrate.

In some embodiments, the Ru salt includes ruthenium acetylacetonate, ruthenium sulfate, ruthenium acetate, ruthenium citrate, ruthenium iodide, ruthenium chloride, ruthenium perchlorate, ruthenium nitrate, ruthenium phosphate, ruthenium triflate, ruthenium bis(trifluoromethanesulfonyl)imide, ruthenium tetrafluoroborate, ruthenium bromide, and/or its hydrate.

In some embodiments, the method includes aerosolizing the solution to form an aerosol with an aerosol generator. The aerosol generator includes a fluid chamber having a housing inlet, a housing outlet, and a vent. A vibrating element is operably coupled to the support plate for generating the aerosol. The solution is introduced into the fluid chamber via the housing inlet, and the fluid chamber is in fluid communication with the heating chamber via the housing outlet. Further, the carrier gas is introduced into the fluid chamber via the vent, thereby carrying the aerosol into the heating chamber.

In yet another exemplary embodiment, a method for electrochemical water splitting is described. The method includes applying a potential between a counter and a working electrode in an electrochemical cell containing an electrolyte to form hydrogen and oxygen. The method further includes separately collecting H₂-enriched gas and O₂-enriched gas. The working electrode includes the electrode as described above, and the electrolyte includes an aqueous solution of a base at a concentration of 0.05 to 5 molar (M).

In some embodiments, the base is at least one selected from the group consisting of sodium hydroxide (NaOH), potassium hydroxide (KOH), lithium hydroxide (LiOH), barium hydroxide (Ba(OH)₂), calcium hydroxide (Ca(OH)₂).

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a method flowchart for making an electrode (RuCo@NF) constituting a bimetallic ruthenium-cobalt (RuCo) alloy electrocatalyst deposited on nickel foam (NF), according to certain embodiments.

FIG. 1B is a method flowchart for electrochemical water splitting, according to certain embodiments.

FIG. 2 shows X-ray diffraction (XRD) patterns of metallic cobalt (Co), ruthenium (Ru), and RuCo alloy catalyst films deposited on a plain glass substrate via aerosol-assisted chemical vapor deposition (AACVD) process, according to certain embodiments.

FIG. 3A is a scanning electron microscopy (SEM) image of monometallic Co deposited on nickel foam (NF) substrate (Co@NF) at 10 micrometers (μm) magnification, according to certain embodiments.

FIG. 3B is a SEM image of monometallic Ru deposited on the NF substrate (Ru@NF) at 10 μm magnification, according to certain embodiments.

FIG. 3C is a SEM image of bimetallic RuCo deposited on the NF substrate (RuCo@NF), at 10 μm magnification, according to certain embodiments.

FIG. 3D is a SEM image of the Co@NF electrode at 2 μm magnification, according to certain embodiments.

FIG. 3E is a SEM image of the Ru@NF electrode at 2 μm magnification, according to certain embodiments.

FIG. 3F is a SEM image of the RuCo@NF electrode at 2 μm magnification, according to certain embodiments.

FIG. 4A is an energy-dispersive X-ray (EDX) spectrum of the Co@NF electrode, according to certain embodiments.

FIG. 4B is an SEM micrograph of the Co@NF electrode showing the area scanned to obtain the corresponding EDX spectrum of the Co@NF electrode, according to certain embodiments.

FIG. 4C is an EDX spectrum of the Ru@NF electrode, according to certain embodiments.

FIG. 4D is an SEM micrograph of the Ru@NF electrode showing the area scanned to obtain the corresponding EDX spectrum of the Ru@NF electrode, according to certain embodiments.

FIG. 4E is an EDX spectrum of the RuCo@NF electrode, according to certain embodiments.

FIG. 4F is an SEM micrograph of the RuCo@NF electrode showing the area scanned to obtain the corresponding EDX spectrum of the RuCo@NF electrode, according to certain embodiments.

FIG. 5A is an EDX elemental mapping analysis of the Co@NF electrode, according to certain embodiments.

FIG. 5B is an EDX elemental mapping image of Co corresponding to the Co@NF electrode, according to certain embodiments.

FIG. 5C is an EDX elemental mapping analysis of the Ru@NF electrode, according to certain embodiments.

FIG. 5D is an EDX elemental mapping image Ru corresponding to the Co@NF electrode, according to certain embodiments.

FIG. 6A is EDX elemental mapping analysis of the RuCo@NF electrode, according to certain embodiments.

FIG. 6B is an EDX elemental mapping image of Co corresponding to the RuCo@NF electrode, according to certain embodiments.

FIG. 6C is an EDX elemental mapping image of Ru corresponding to the RuCo@NF electrode, according to certain embodiments.

FIG. 7A is a transmission electron microscopy (TEM) image of RuCo alloy electrocatalyst at a magnification of 100 nanometers (nm), according to certain embodiments.

FIG. 7B is a TEM image of RuCo alloy electrocatalyst at a magnification of 50 nm, respectively, according to certain embodiments.

FIG. 7C is an image showing a high-resolution transmission electron microscopic (HRTEM) image of RuCo alloy electrocatalyst at 10 nm marked with lattice fringes, according to certain embodiments.

FIG. 7D is a selected area electron diffraction (SAED) pattern image showing polycrystalline diffraction pattern of RuCo alloy electrocatalyst, according to certain embodiments.

FIG. 8A is an X-ray photoelectron spectroscopy (XPS) survey scan spectrum of RuCo alloy electrocatalyst, according to certain embodiments.

FIG. 8B is a high-resolution XPS spectrum of C 1s and Ru 3d involved in RuCo alloy electrocatalyst, according to certain embodiments.

FIG. 8C is a high-resolution XPS spectrum of Co 2p involved in RuCo alloy electrocatalyst, according to certain embodiments.

FIG. 9A is a cyclic voltammetry (CV) curve for the Co@NF electrode performed at a scan speed of 50 mVs⁻¹ in 1.0 M KOH electrolyte, according to certain embodiments.

FIG. 9B is a CV curve for the Ru@NF electrode performed at a scan speed of 50 mVs⁻¹ in 1.0 M KOH electrolyte, according to certain embodiments.

FIG. 9C is a CV curve for the RuCo@NF electrode performed at a scan speed of 50 mVs⁻¹ in 1.0 M KOH electrolyte, according to certain embodiments.

FIG. 9D is a comparison curve of 500^{th} CV of Ru@NF, Co@NF, and the RuCo@NF electrodes, according to certain embodiments.

FIG. 10A is a linear sweep voltammetry (LSV) curve of catalysts acquired in 1.0 M KOH at 2 mVs⁻¹, according to certain embodiments.

FIG. 10B is a comparison curve of overpotential (η) of various catalysts at 10 mAcm⁻² and 100 mAcm⁻², according to certain embodiments.

FIG. 10C shows Tafel slopes derived from corresponding LSV curves of various electrodes, according to certain embodiments.

FIG. 10D are Nyquist plots for various electrodes, according to certain embodiments.

FIG. 11A shows CVs obtained in the non-Faradaic region for the Co@NF electrode, according to certain embodiments.

FIG. 11B shows CVs obtained in the non-Faradaic region for the Ru@NF electrode, according to certain embodiments.

FIG. 11C shows CVs obtained in the non-Faradaic region for the RuCo@NF electrode, according to certain embodiments.

FIG. 11D is a graph showing current density versus scan rate curve to measure double-layer charge capacitance (C_{dl}) value of various electrodes, according to certain embodiments.

FIG. 12A is a graph showing chrono-potentiometric (CP) stability profile of as-synthesized electrocatalysts, measured at a fixed current density of 50 mAcm⁻² in 1.0 M KOH electrolyte for 24 hours (h), according to certain embodiments.

FIG. 12B is a polarization curve of bimetallic RuCo alloy before and after the stability test, according to certain embodiments.

FIG. 13A is an image showing a low magnification SEM analysis of the bimetallic RuCo alloy electrocatalyst after performing the hydrogen evolution reaction (HER) process in a 1.0 M KOH electrolyte, according to certain embodiments.

FIG. 13B is an image showing a high magnification SEM analysis of the bimetallic RuCo alloy electrocatalyst after performing the HER process in a 1.0 M KOH electrolyte, according to certain embodiments.

FIG. 13C is an EDX spectrum of the bimetallic RuCo alloy electrocatalyst after performing the HER process in a 1.0 M KOH electrolyte, according to certain embodiments.

FIG. 13D is an EDX elemental mapping analysis showing the presence of Ru and Co elements in the bimetallic RuCo alloy electrocatalyst after performing the HER process in a 1.0 M KOH electrolyte, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a”, “an” and the like generally carry a meaning of “one or more,” unless stated otherwise.

Furthermore, the terms “approximately”, “approximate”, “about”, and similar terms generally refer to ranges that include the identified value within a margin of 20%, 10%, or preferably 5%, and any values therebetween.

The use of the terms “include”, “includes”, “including,” “have,” “has,” or “having” should be generally understood as open-ended and non-limiting unless specifically stated otherwise.

As used herein, “nanoparticles” are particles having a particle size of 1 nm to 500 nm within the scope of the present invention.

As used herein, “particle size” and “pore size” may be thought of as the lengths or longest dimensions of a particle and of a pore opening, respectively.

As used herein, the term “room temperature” refers to a temperature range of “25° C.±3° C. in the present disclosure.

As used herein, the term “electrode” refers to an electrical conductor used to contact a non-metallic part of a circuit, such as a semiconductor, an electrolyte, a vacuum, or air.

As used herein, the term “current density” refers to the amount of electric current traveling per unit cross-section area.

As used herein, the term “Tafel slope” refers to the relationship between the overpotential and the logarithmic current density.

As used herein, the term “electrochemical cell” refers to a device capable of either generating electrical energy from chemical reactions or using electrical energy to cause chemical reactions.

As used herein, the term “aerosolizing” refers to a process of intentionally oxidatively converting a solution to deliver the oxidized aerosols to the heating chamber.

As used herein, the term “aerosol” refers to extremely small solid particles or liquid droplets suspended in the atmosphere.

As used herein, the term “water splitting” refers to the chemical reaction in which water is broken down into oxygen and hydrogen.

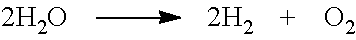

As used herein, the term “overpotential” “refers to the difference in potential that exists between a thermodynamically determined reduction potential of a half-reaction and the potential at which the redox event is experimentally observed. The term is directly associated with a cell's voltage efficacy. In an electrolytic cell, the occurrence of overpotential implies that the cell needs more energy as compared to that thermodynamically needed to drive a reaction. The quantity of overpotential is specific to each cell design and varies across cells and operational conditions, even for the same reaction. Overpotential is experimentally measured by determining the potential at which a given current density is reached.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of naturally occurring nickel ²⁸Ni include ⁵⁸Ni, ⁶⁰Ni, ⁶¹Ni, ⁶²Ni, and ⁶⁴Ni. Isotopes of oxygen include ¹⁶O, ¹⁷O, and ¹⁸O and isotopes of cobalt (Co) are ⁵⁶Co, ⁵⁷Co, ⁵⁸Co, and ⁶⁰Co. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed to a bimetallic ruthenium-cobalt (RuCo) alloy electrocatalyst fabricated using a facile deposition strategy based on aerosol-assisted chemical vapor deposition (AACVD). The metallic synergy between Co and Ru metals and the structural advantages of RuCo alloy catalyst, lead toward remarkably enhanced electrocatalytic performance as compared to the monometallic components. The present disclosure also describes a convenient route for preparing highly active and robust bimetallic thin film electrocatalysts for efficient hydrogen production in fuel cell applications.

An electrode is described. The electrode includes a bimetallic ruthenium-cobalt (RuCo) alloy electrocatalyst. The electrode includes a metallic substrate and a layer of a RuCo alloy at least partially covering the surface of the metallic substrate. In some embodiments, the substrate is at least one metal foam selected from aluminum foam, a nickel foam, a titanium foam, a titanium alloy foam, an aluminum alloy foam, a magnesium alloy foam, a nickel alloy foam, and a steel foam. In a preferred embodiment, the metallic substrate is a nickel foam. In some embodiments, the particles of the RuCo@NF are dispersed on the substrate, preferably nickel foam, to form the electrode. The particles cover at least 50%, preferably 55%, preferably 60%, preferably 65%, preferably 70%, preferably 75%, preferably 80%, preferably 85%, preferably 90%, and preferably >95% of the substrate. In some embodiments, the RuCo alloy may be dispersed on the surface of the substrate using one of the techniques like the drop-casting method, spray coating, spin coating, dip coating, or AACVD method. In a preferred embodiment, the RuCo alloy may be dispersed on the surface of the substrate using the AACVD method.

The layer of the RuCo@NF includes spherical-shaped particles having an average particle size of 0.5-5 micrometers (μm), preferably 1.0-4.5 μm, preferably 1.5-4.0 μm, preferably 2.0-3.5 μm, and preferably 2.5-3.0 μm. The regularly connected spheres made the surface thick and dense. In alternate embodiments, the layer of the RuCo@NF may include particles with different shapes, such as cones, cuboidal, pyramidical, cylindrical, wires, crystals, rectangles, triangles, prisms, disks, cubes, ribbons, blocks, beads, discs, barrels, granules, whiskers, flakes, foils, powders, boxes, stars, flowers, polygonal like trigonal, pentagonal, hexagonal, etc., and mixtures thereof. In some embodiments, the spherical-shaped particles of the RuCo@NF have an average particle size of 1 to 3 μm, preferably 1.5-2.5 μm. In some embodiments, the spherical-shaped particles of the RuCo@NF are aggregated.

In some embodiments, the RuCo@NF includes about 25-36 weight percentage (wt. %) of Ru, preferably 26-35 wt. %, preferably 27-34 wt. %, preferably 28-33 wt. %, preferably 29-32 wt. %, and preferably 30-31 wt. % of Ru; and about 58-68 wt. % of Co, preferably 59-67 wt. %, preferably 60-66 wt. %, preferably 61-65 wt. %, and preferably 62-64 wt. %, each wt. % based on total weight of the RuCo@NF. In a preferred embodiment, the RuCo@NF includes about 31.2 wt. % of Ru and about 63.4 wt. % of Co; each wt. % is based on the total weight of the RuCo@NF.

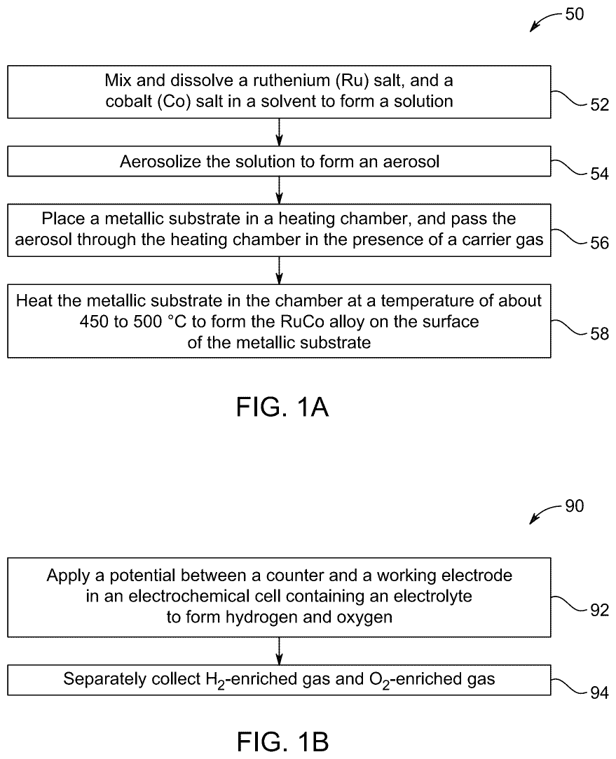

FIG. 1A illustrates a flow chart of a method 50 of making the RuCo@NF electrode. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing and dissolving a ruthenium salt, and a cobalt salt in a solvent to form a solution. Suitable examples the cobalt salt include cobalt acetylacetonate, cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or its hydrate. In a preferred embodiment, the cobalt salt is cobalt (II) acetylacetonate Co(acac)₂. Suitable examples of ruthenium salt include ruthenium acetylacetonate, ruthenium sulfate, ruthenium acetate, ruthenium citrate, ruthenium iodide, ruthenium chloride, ruthenium perchlorate, ruthenium nitrate, ruthenium phosphate, ruthenium triflate, ruthenium bis(trifluoromethanesulfonyl)imide, ruthenium tetrafluoroborate, ruthenium bromide, and/or its hydrate. In a preferred embodiment, the ruthenium salt is ruthenium (III) acetylacetonate (Ru(acac)₃). In some embodiments, the solvent is at least one selected from a ketone solvent, an ester solvent, an alcohol solvent, an amide solvent, and an ether solvent. Suitable examples of ketone solvents include acetone and acetophenone; suitable examples of ester solvents include ethyl acetate and methyl salicylate; suitable examples of an alcohol solvent include ethanol, isopropyl alcohol; suitable examples of amide solvents include dimethylformamide (DMF), acetamide, and suitable examples of ether solvent include diethyl ether and tetrahydrofuran (THF). In a preferred embodiment, the solvent is an alcohol, preferably methanol. The mixing may be carried out manually or with the help of a stirrer. In some embodiments, the mixture includes a molar ratio of the Ru salt to the Co salt in a range of 1:1 to 1:4 and preferably 1:2 to 1:3. In a preferred embodiment, the mixture includes a molar ratio of the Ru salt to the Co salt of 1:2. The mixing is carried out till the particles are fully dissolved in the solvent until a homogenous solution is obtained.

At step 54, the method 50 includes aerosolizing the solution to form an aerosol. The aerosolizing is performed with an aerosol generator, including a fluid chamber with a housing inlet, a housing outlet, a vent, and a vibrating element operably coupled to the support plate for generating the aerosol. The solution is introduced into the fluid chamber via the housing inlet. The fluid chamber is in fluid communication with the heating chamber via the housing outlet. A carrier gas is introduced into the fluid chamber via the vent, thereby carrying the aerosol into the heating chamber.

At step 56, the method 50 includes placing the metallic substrate in a heating chamber and passing the aerosol through the heating chamber in the presence of a carrier gas. In some embodiments, the metallic substrate is in direct contact with the aerosol. In some embodiments, the carrier gas is nitrogen, hydrogen, helium, and argon. In a preferred embodiment, the carrier gas is nitrogen.

At step 58, the method 50 includes heating the metallic substrate in the chamber at a temperature of about 450-500 degrees Celsius (° C.), preferably 455-495° C., preferably 460-490° C., preferably 465-485° C., and preferably 470-480° C. to form the RuCo@NF on the surface of the metallic substrate. In a preferred embodiment, the metallic substrate is heated in the chamber at a temperature of 475° C. In some embodiments, at least a portion of the Ru salt and the Co salt present in the aerosol is decomposed to generate the RuCo@NF during the heating.

FIG. 1B illustrates a flow chart of a method 90 of electrochemical water splitting. The order in which the method 90 is described is not intended to be construed as a limitation, and any number of the described method steps can be combined in any order to implement the method 90. Additionally, individual steps may be removed or skipped from the method 90 without departing from the spirit and scope of the present disclosure.

At step 92, the method 90 includes applying a potential between a counter and a working electrode in an electrochemical cell containing an electrolyte to form hydrogen and oxygen. The method includes applying a potential of −0.5 to −1.5 volts (V), preferably −0.6 to −1.4 V, preferably −0.7 to −1.3 V, preferably −0.8 to −1.2 V, and preferably −0.9 to −1.1 V to an electrochemical cell. The electrochemical cell includes the RuCo@NF-based electrode and a counter electrode. In some embodiments, the counter electrode is made from a material selected from the group consisting of platinum, gold, and carbon. In some embodiments, the counter electrode may contain an electrically-conductive material such as platinum, platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10⁻⁶ Ω·m, preferably at most 10⁻⁷ Ω·m, more preferably at most 10⁻⁸ Ω·m at a temperature of 20-25° C. The form of the counter electrode may be generally relevant only in that it needs to supply sufficient current to the electrolyte solution to support the current required for the electrochemical reaction of interest. The counter electrode material should thus be sufficiently inert to withstand the chemical conditions in the electrolyte solution, such as acidic or basic pH values, without substantially degrading during the electrochemical reaction. The counter electrode should preferably not leach out any chemical substance that interferes with the electrochemical reaction or might lead to undesirable electrode contamination. In a preferred embodiment, the counter electrode is platinum.

In one embodiment, the electrochemical cell further includes a reference electrode in contact with the electrolyte solution. A reference electrode is an electrode that has a stable and well-known electrode potential. The high stability of the electrode potential is usually reached by employing a redox system with constant (buffered or saturated) concentrations of each relevant species of the redox reaction. A reference electrode may enable a potentiostat to deliver a stable voltage to the working electrode or the counter electrode. The reference electrode may be a standard hydrogen electrode (SHE), a normal hydrogen electrode (NHE), a reversible hydrogen electrode (RHE), a saturated calomel electrode (SCE), a copper-copper(II) sulfate electrode (CSE), a silver chloride electrode (Ag/AgCl), a pH-electrode, a palladium-hydrogen electrode, a dynamic hydrogen electrode (DHE), a mercury-mercurous sulfate electrode, mercury/mercuric oxide (Hg/HgO) electrode, or some other type of electrode. In a preferred embodiment, a reference electrode is an Hg/HgO electrode. However, in some embodiments, the electrochemical cell does not include a third electrode.

In some embodiments, the electrochemical cell is at least partially submerged in an electrolyte, preferably 50%, preferably 60%, or more preferably at least 70%. In some embodiments, the aqueous solution includes water and a base. The water may be tap water, distilled water, bidistilled water, deionized water, deionized distilled water, reverse osmosis water, and/or some other water. In some embodiments, the electrolyte includes the aqueous solution of the base at a concentration of 0.05-0.5 M, preferably 0.1-0.45, preferably 0.15-0.4, preferably 0.2-0.35,and preferably 0.25-0.3 M. In a preferred embodiment, the electrolyte includes the aqueous solution of a base at a concentration of 1 M. In some embodiments, the base is at least one selected from the group consisting of sodium hydroxide (NaOH), potassium hydroxide (KOH), lithium hydroxide (LiOH), barium hydroxide (Ba(OH)₂), calcium hydroxide (Ca(OH)₂). In an alternative embodiment, an organic base may be used, such as sodium acetate and potassium acetate. Preferably, to maintain uniform concentrations and/or temperatures of the electrolyte solution, the electrolyte solution may be stirred or agitated during the step of the subjecting. The stirring or agitating may be done intermittently or continuously. This stirring or agitating may be done by a magnetic stir bar, a stirring rod, an impeller, a shaking platform, a pump, a sonicator, a gas bubbler, or some other device. Preferably, the stirring is done by an impeller or a magnetic stir bar.

At step 94, the method 90 includes separately collecting H₂-enriched gas and O₂-enriched gas. The oxygen may be generated by decomposing water into H₂ and O₂. In one embodiment, the space above each electrode may be confined to a vessel to receive or store the evolved gases from one or both electrodes. The collected gas may be further processed, filtered, or compressed. Preferably, the H₂-enriched gas is collected above the cathode, and the O₂-enriched gas is collected above the anode. The electrolytic cell, or an attachment, may be shaped so that the headspace above the working electrode is kept separate from the headspace above the reference electrode. In one embodiment, the H₂-enriched gas and the O₂-enriched gas are not 100 vol % H₂ and 100 vol % O₂, respectively. For example, the enriched gases may also include N₂ from the air, water vapor, and other dissolved gases from the electrolyte solution. The H₂-enriched gas may also include O₂ from the air. The H₂-enriched gas may include greater than 20 vol % H₂, preferably greater than 40 vol % H₂, more preferably greater than 60 vol % H₂, and even more preferably greater than 80 vol % H₂, relative to a total volume of the receptacle collecting the evolved H₂ gas. The O₂-enriched gas may include greater than 20 vol % O₂, preferably greater than 40 vol % O₂, more preferably greater than 60 vol % O₂, and even more preferably greater than 80 vol % O₂, relative to a total volume of the receptacle collecting the evolved O₂ gas. In some embodiments, the evolved gases may be bubbled into a vessel, including water or some other liquid, and higher concentrations of O₂ or H₂ may be collected. In one embodiment, evolved O₂ and H₂, or H₂-enriched gas and O₂-enriched gas, may be collected in the same vessel.

In some embodiments, the electrode has an overpotential of about 15-20 millivolts (mV), preferably 16-19 mV, and preferably 17-18 mV, relative to the reversible hydrogen electrode (mV_{RHE}) at a current density of about 10 milliamperes per square centimeter (mA/cm²). In a preferred embodiment, the electrode has an overpotential of about 17 mV_{RHE} at a current density of about 10 mA/cm². In some embodiments, the electrode has an overpotential of about 80-120 mV_{RHE}, preferably 85-115 mV_{RHE}, preferably 90-110 mV_{RHE}, and preferably 95-105 mV_{RHE} at a current density of about 100 mA/cm². In a preferred embodiment, the electrode has an overpotential of about 100 mV_{RHE} at a current density of about 100 mA/cm². In some embodiments, the electrode has an overpotential of about 70-100 mV_{RHE}, preferably 75-95 mV_{RHE}, and preferably 80-90 mV_{RHE} at a current density of about 50 mA/cm² for at least 24 h. In some embodiments, the electrode has a Tafel slope of 30-50 millivolt/decade (mV dec⁻¹), preferably 31-49 mV dec⁻¹, preferably 32-48 mV dec⁻¹, preferably 33-47 mV dec⁻¹, preferably 36-46 mV dec⁻¹, preferably 37-45 mV dec⁻¹, preferably 38-44 mV dec⁻¹, preferably 39-43 mV dec⁻¹, and preferably 40-42 mV dec⁻¹. In a preferred embodiment, the electrode has a Tafel slope of 42 mV dec⁻¹. In some embodiments, the electrode has a charge transfer resistance (Rct) of about 1.6-2.2 ohms (Ω), preferably 1.7-2.1 Ω, and preferably 1.8-2.0 Ω as determined by electrochemical impedance spectroscopy (EIS).

### EXAMPLES

The following examples demonstrate an electrode including a bimetallic ruthenium-cobalt (RuCo) alloy electrocatalyst. The examples are provided solely for illustration and are not to be construed as limitations of the present disclosure, as many variations thereof are possible without departing from the spirit and scope of the present disclosure.

### Example 1: Chemicals

The chemical precursors, cobalt (II) acetylacetonate (Co(acac)₂ 97%) and ruthenium (III) acetylacetonate (Ru(acac)₃), 97%) and solvent (methanol) were obtained from Sigma-Aldrich. These chemicals were directly used in the experiments without any purification.

### Example 2: Fabrication of RuCo Alloy via Aerosol-Assisted Chemical Vapor Deposition (AACVD) Process

The bimetallic RuCo alloy electrocatalyst was fabricated using a house-designed AACVD. Prior to starting the deposition process, nickel foam (NF) was cleaned with different solvents (diluted HCl, acetone, ethanol DI water) and finally dried under a flow of inert gas (nitrogen). The precursors Co(acac)₂ [50 milligrams (mg) and 194 millimole (mmol)] and Ru(acac)₃ (39 mg and 97 mmol) were dissolved into 15 milliliters (mL) methanol to obtain a red color homogenous solution. An aerosol mist was generated from the binary precursor solution using an ultrasonic humidifier. The aerosol mist was driven towards a horizontal tube furnace, which had a quartz glass tube and nickel foam substrate set at a temperature of 475 degrees Celsius (° C.). Inert nitrogen gas (99.999% purity) at a flow rate of 100 cm³/min was used as an aerosol carrier. The incorporation of aerosol-mist into the hot region of the reactor experienced CVD gas phase reactions and precursor decomposition resulting in RuCo alloy on exposed nickel foam substrate. The deposition process was continued for 1 hour (h). After that, the aerosol supply was stopped, and the furnace was switched off to cool under the flow of nitrogen gas. The resulting alloy catalyst was named RuCo@NF. For comparison, metallic ruthenium (Ru) and cobalt (Co) films were also grown on the NF using a similar AACVD process. Each Co/Ru acetylacetonate precursor (50 mg) was dissolved separately in methanol (10 mL) to obtain pristine the Co@NF and the Ru@NF films sample as a result of 1 h of the AACVD deposition process.

### Example 2: Structural Characterization

The X-ray diffraction (XRD) pattern was measured with a Rigaku MiniFlex X-ray diffractometer. The surface morphology of the developed catalyst was examined with scanning electron microscopy (SEM), TESCAN MIRA3. The elemental stoichiometry of the catalyst was determined with an X-ray dispersive energy analyzer (EDX), INCA Energy 200, Oxford Instruments, UK. The transmission electron microscopy (TEM) JEOL-JEM2100F, Japan, operated at an acceleration voltage of 200 kilovolts (kV) was used for in-depth structural analysis of the catalyst. X-ray photoelectron spectroscopy (XPS) analysis was conducted using Thermo Scientific EscaLab 250Xi, USA, with an Al Kα (1486.6 eV) source to reveal the elemental composition with the chemical and electronic state of the atoms in the structure.

### Example 3: Electrochemical Hydrogen Evolution Reaction (HER) Measurements

The electrochemical HER measurements were made via Autolab potentiostat (Nova 2.1.6 interface) connected to a computer. A three-electrode set-up included Hg/HgO, platinum (Pt) rod, and AACVD deposited electrodes (Ru/Co/RuCo on NF) named as the reference, counter, and working electrodes, respectively were immersed in 1.0 molar (M) potassium hydroxide (KOH). A cyclic voltammetry (CV) test was performed in the potential range of −0.5 to −1.5 V (vs. Hg/HgO) for initial stability examination. The linear sweep voltammetry (LSV) curves were measured at a scan rate of 2 mVs⁻¹ and the data obtained are reported after iR corrections. Electrochemical impedance spectroscopy (EIS) was estimated at a potential of 50 mV (RHE) in the frequency range from 0.01 Hz to 100 kHz. The chronopotentiometry (CP) test was conducted to assess the long-term stability of the working electrodes at a fixed current density of 50 mAcm⁻². All measured potentials were converted to the reversible hydrogen electrode (RHE). The electrochemically active surface area (ECSA) was calculated using the following relationship:

$$E S C A = \frac{{C}_{DL}}{{C}_{S}}$$

The electrochemical double-layer capacitance (C_{dl}) of all catalysts was determined by running successive CVs in the non-Faradic region of 370-180 mV (RHE) by varying scan rate from 10 to 60 mV sec⁻¹. Where, Cₛ represents the specific capacitance of the metal electrodes, which is 0.04 cm² for alkaline electrolytes. The C_{dl} is determined from the cathodic and anodic slopes of the average current versus the sampling rate curve.

### Example 4: Structural Analysis

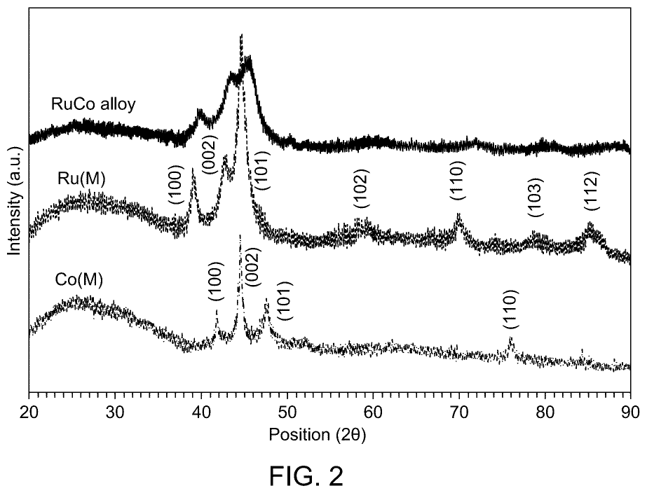

The crystalline structure of monometallic Co@NF, Ru@NF, and bimetallic RuCo@NF alloy was analyzed by XRD analysis. The high crystalline Ni peaks from the NF support overcome the XRD peaks of the deposited material. Therefore, the catalyst films were reproduced on the non-crystalline surface of plain glass by following the same AACVD procedure as described. Further, FIG. 2 indicates the XRD patterns of monometallic Co, Ru, and bimetallic RuCo alloy deposited on plain glass. The metallic Co was characterized by its XRD peaks at 2θ 41.8°, 44.6°, 47.6° and 76° produced from the lattice planes of (100), (002), (101), and (110), respectively, referring to the formation of hexagonal “Cobalt (Co)” metal (ICDD No: 01-077-7453). XRD pattern of metallic Ru exhibited crystalline peaks at 38.7°, 42.5°, 44.5°, 58.9°, 69.8°, 78.9°, and 85.2° which were assigned to the (100), (002), (101), (102), (110), (103) and (112) planes of standard hexagonal “Ruthenium (Ru)” metal (ICDD No: 01-073-7011). The addition of Co into the Ru lattice shifted these diffraction peaks towards larger angles. The resultant RuCo alloy peaks emerged at 40.0°, 43.5°, 45.6°, 60.6°, 72.5°, 81.4° and 88.8° were attributed to the (100), (002), (101), (102), (110), (103), and (112) planes of standard hexagonal “RuCo” alloy, respectively (ICDD No: 03-065-8976). The XRD patterns of metallic Co and Ru display clear crystalline peaks, however, the RuCo alloy indicated relatively less crystalline behavior. The wide diffraction peaks indicate the formation of small-sized hexagonal RuCo alloy.

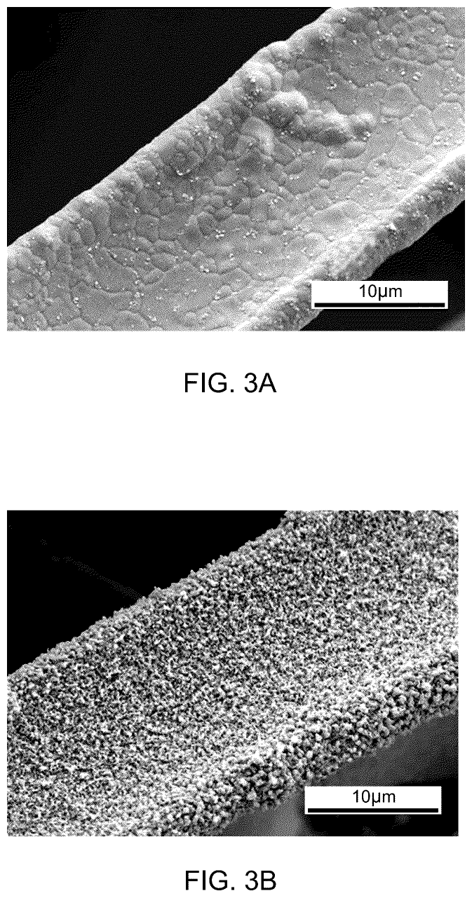

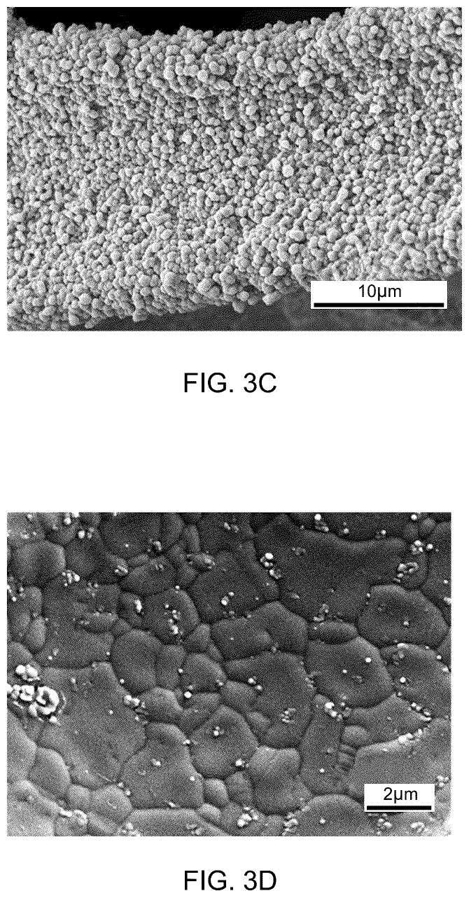

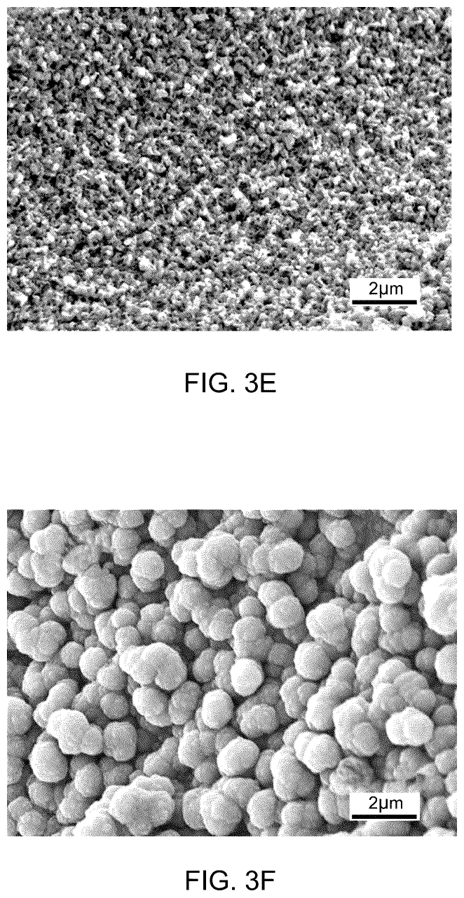

The microstructure of as-synthesized catalytic film samples was investigated by SEM. FIGS. 3A-3C show SEM images of Co@NF, Ru@NF, and the RuCo@NF electrodes, respectively at 10 μm magnification. FIGS. 3D-3E show SEM images of Co@NF, Ru@NF, and the RuCo@NF electrodes, respectively at 2 μm magnification. In the case of Ru@NF, no specific morphology was detected, and grain boundaries of the NF only appeared due to annealing at elevated temperatures.

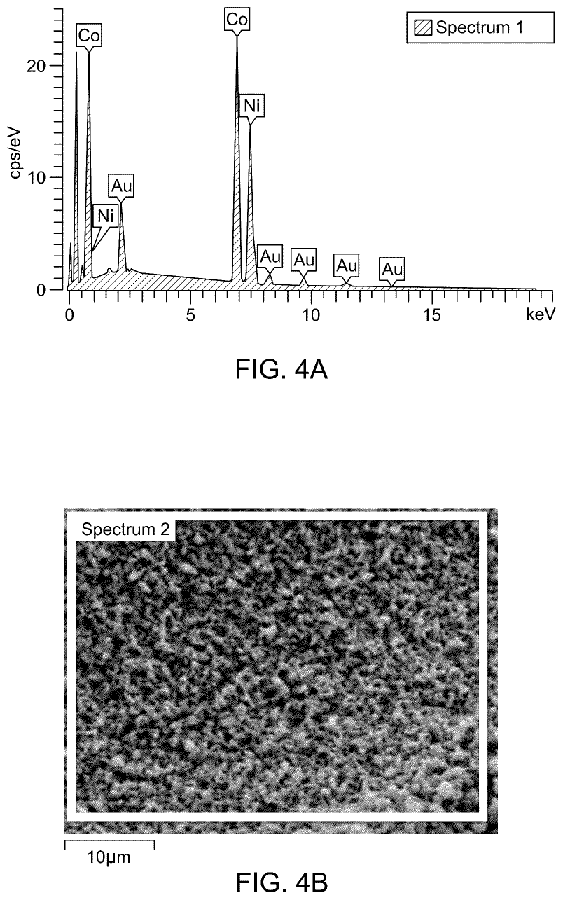

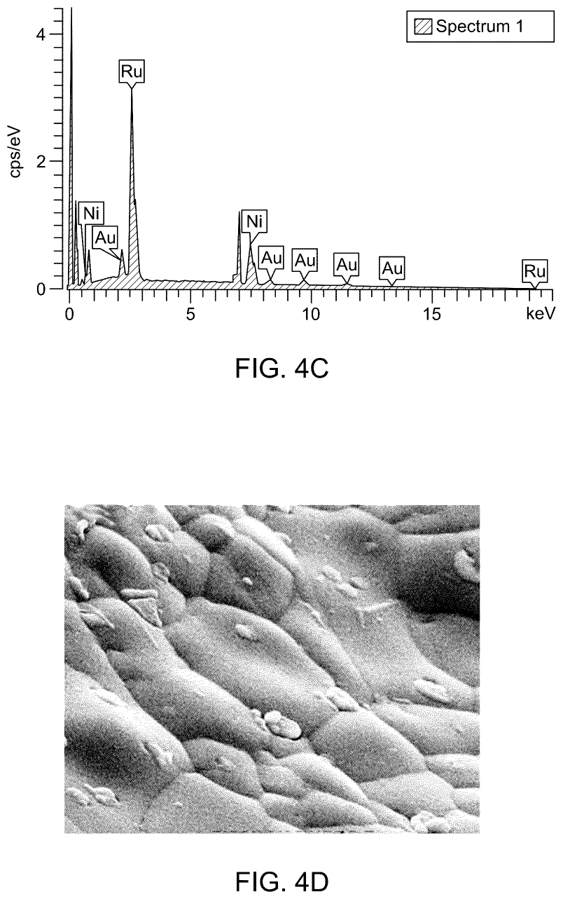

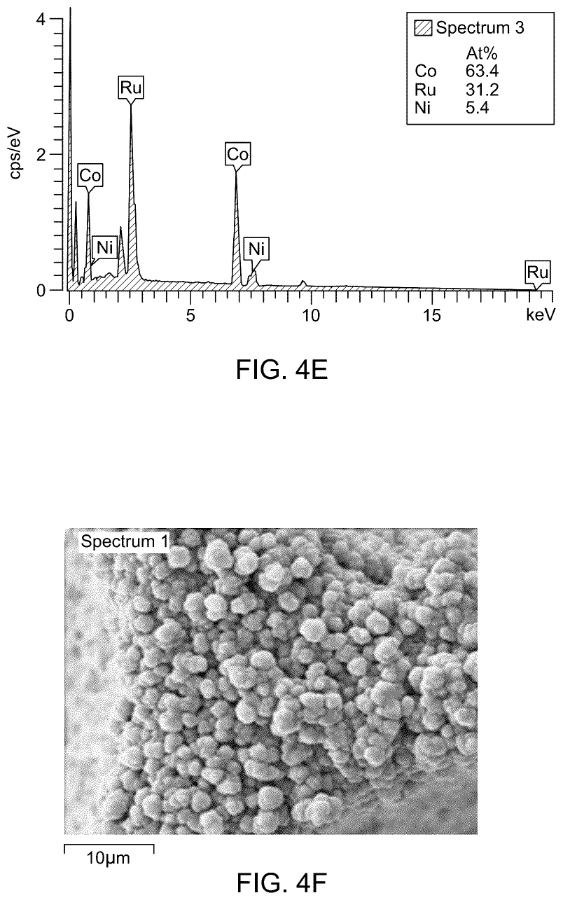

FIG. 4A, FIG.4C, and FIG. 4E show EDX spectra of Co@NF, Ru@NF, and the RuCo@NF electrodes, respectively whereas FIG. 4B, FIG.4D, and FIG. 4F shows corresponding SEM micrographs of the respective electrodes showing the area scanned for obtaining the corresponding EDX spectrum. The EDX map detected a fine layer of Ru grown on the NF surface. On the other hand, pristine Co deposit emerged as a tiny flake-like structure homogenously dispersed on the NF contour. Further, the bimetallic RuCo alloy deposited under AACVD condition evolved as spherical-shaped particles nicely decorated over the NF skeleton. The regularly connected spheres made the surface thick and dense.

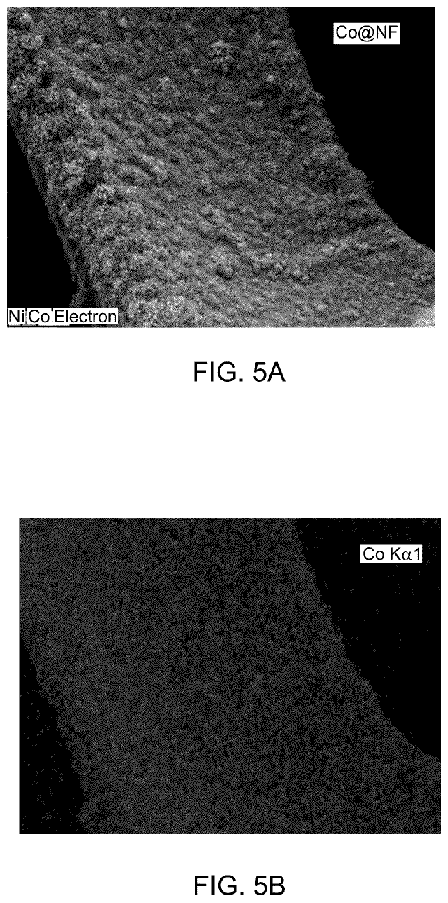

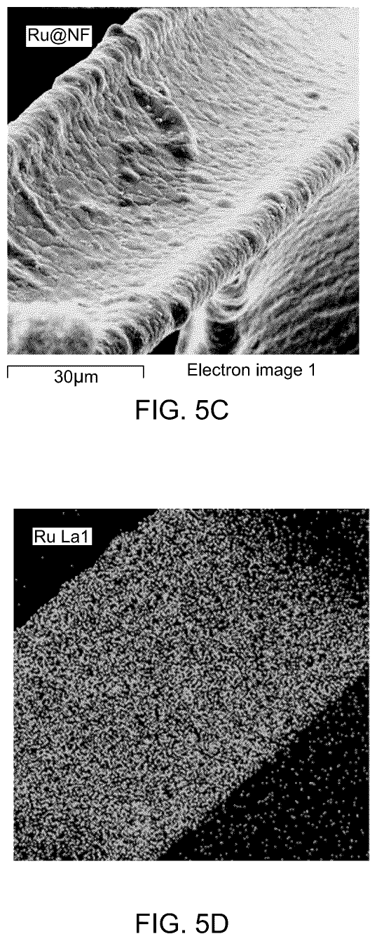

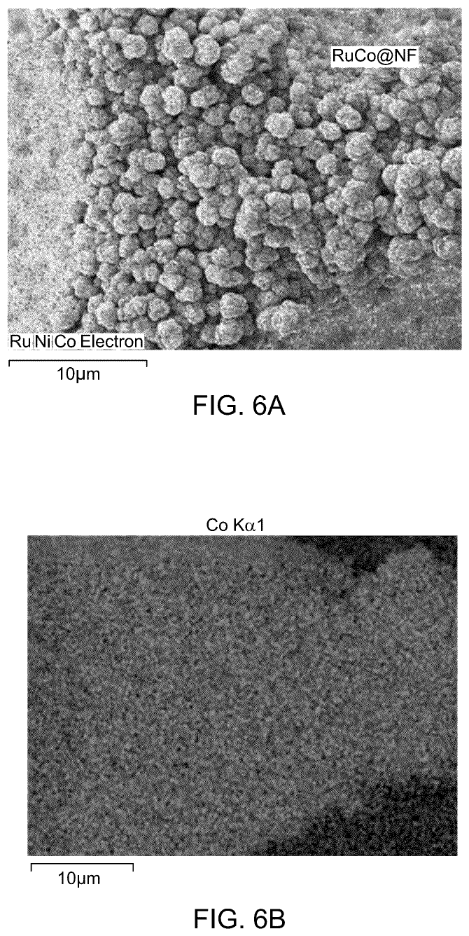

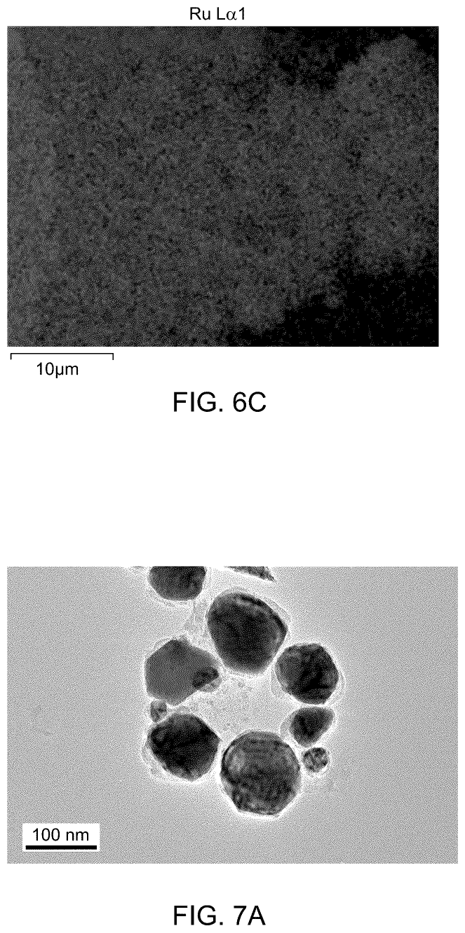

Furthermore, the elemental composition of these catalysts was measured by EDX analysis. FIG. 5A is an EDX elemental mapping analysis of the Co@NF electrode, while FIG. 5B is the corresponding EDX elemental mapping image of Co in the Co@NF electrode. FIG. 5C is an EDX elemental mapping analysis of the Ru@NF electrode, while FIG. 5D is the corresponding EDX elemental mapping image of Ru in the Ru@NF electrode. The monometallic catalysts involved Ru and Co elements in their respective samples, along with Ni elements that appeared from the NF. FIG. 6A is an EDX elemental mapping analysis of the RuCo@NF electrode, while FIG. 6B and 6C are the corresponding EDX elemental mapping images of Co and Ru, respectively, in the RuCo@NF electrode. The bimetallic RuCo alloy showed both Ru and Co elements with a percent atomicity of 31.2% and 63.4%, indicatinging an empirical metallic ratio of 1:2 in the alloy sample. No oxygen peak was observed in these EDX patterns, signifying the synthesis of pure monometallic and alloy materials. Moreover, the EDX map confirmed the homogenous distribution of Ru and Co in the as-prepared RuCo alloy samples.

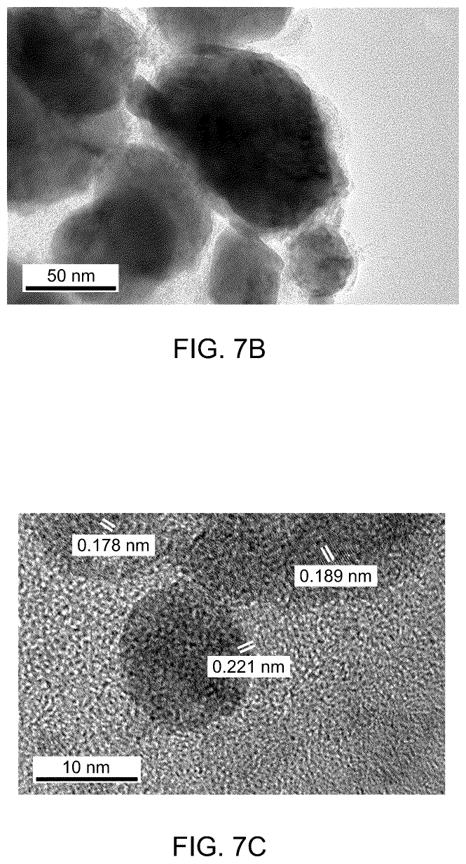

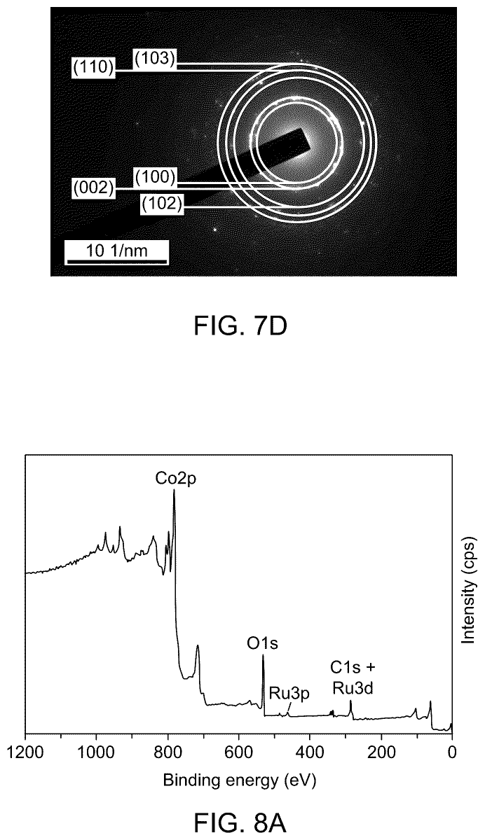

The morphology and crystalline structure of RuCo alloy were thoroughly examined by TEM analysis. FIG. 7A and FIG. 7B depicts TEM image of RuCo alloy electrocatalyst at 100 and 50 nm. It depicts the round-shaped particles of varying diameters stacked with each other, showing structural resemblance with FIG. 3F. Further, high-resolution TEM (HRTEM) image, as shown in FIG. 7C reveals that lattice fringe spaces of 0.22 nm and 0.189 nm are, respectively, consistent with the (100) and (101) planes of the hexagonal RuCo phase. Selected area electron diffraction pattern (SAED), as shown in FIG. 7D, collected from spherical nanoparticles, produced several diffraction rings labeled with corresponding Miller indices (hkl) values. The SAED pattern reveals the polycrystalline nature of RuCo alloy, in agreement with the XRD results of the standard hexagonal RuCo phase.

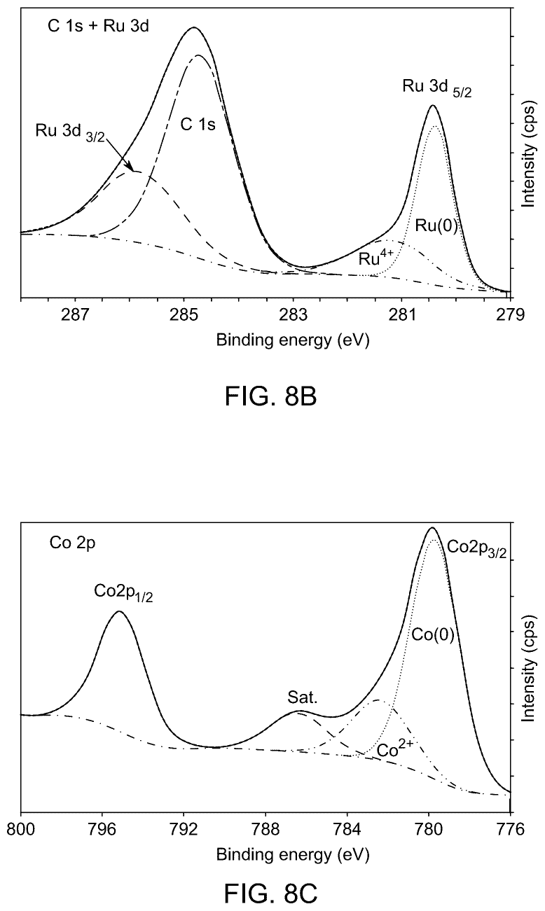

The electronic structure and chemical state of bimetallic RuCo alloy were examined by XPS. The XPS survey spectrum, as depicted in FIG. 8A shows the presence of O, C, Co, and Ru on the surface of the catalyst. As Ru 3d and C 1s peaks generally coincide, therefore, both elements were mutually deconvoluted into sub-peaks, as shown in FIG. 8B. The binding energy peak at 284.6 eV was attributed to the C 1s. The binding energy peaks at 280.4 electron volts (eV) and 285.9 eV may be assigned to Ru 3d_{5/2} and Ru 3d_{3/2}, respectively. The Ru 3d_{5/2} peak indicated two chemical states of Ru, metallic Ru (0) (at 280.3 eV) and Ru⁴⁺ (281.3 eV). The high-resolution Co 2p spectrum, as shown in FIG. 8C, depicts the peaks at 779.3 and 795.1 eV corresponding to metallic Co⁰. Besides, a pair of peaks at 780.96 eV and 796.46 eV is correlated well with CoO, accompanied by the emergence of a satellite peak at 786.62 eV associated with the surface oxidation of RuCo.

### Example 5: Electrochemical HER

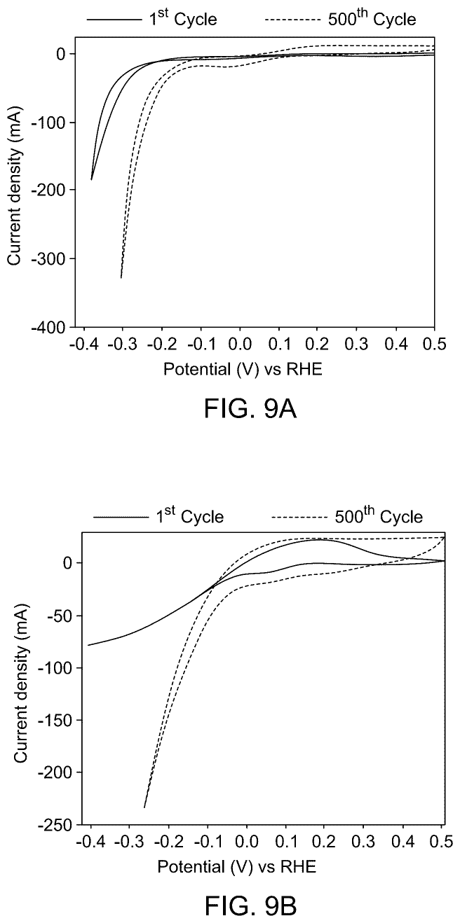

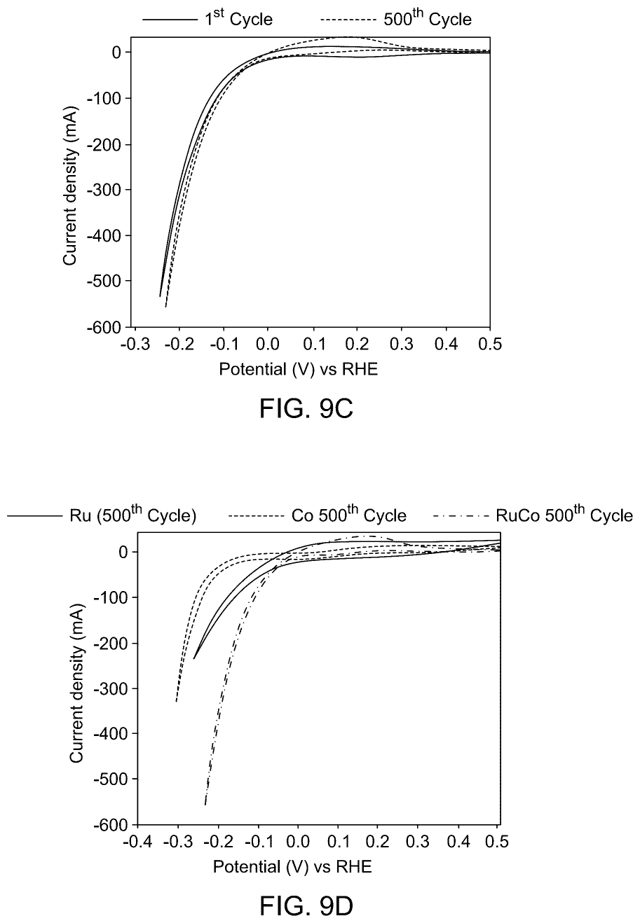

The fabricated electrocatalytic systems, Co@NF, the Ru@NF and the RuCo@NF were assessed for the HER process using a three-electrode system in 1.0 M KOH electrolyte. Initially, cyclic voltammetry (CV) analysis was conducted to observe the electrochemical stability and current behavior of these electrocatalysts. FIG. 9A-9C is a CV curves for the Co@NF electrode, Ru@NF electrode, and RuCo@NF electrode, respectively performed at a scan speed of 50 mVs⁻¹ in 1.0 M KOH electrolyte. In case of pristine the Co@NF and the Ru@NF electrodes, the 500^{th} CV curve was shifted towards lower potential, which is attributed to the activation of catalyst surfaces and better the HER performance. While the bimetallic RuCo alloy produced highly stable and reproducible CV signals as the 1^{st} and 500^{th} CVs were almost identical. This showed that the incorporation of Co into Ru lattice formed a highly stable and inherently more active bimetallic RuCo alloy as compared to their pristine components. FIG. 9D is a comparison curve of 500^{th} CV of Ru@NF, Co@NF, and the RuCo@NF electrodes. It indicates the enhanced activity of the bimetallic RuCo catalyst.

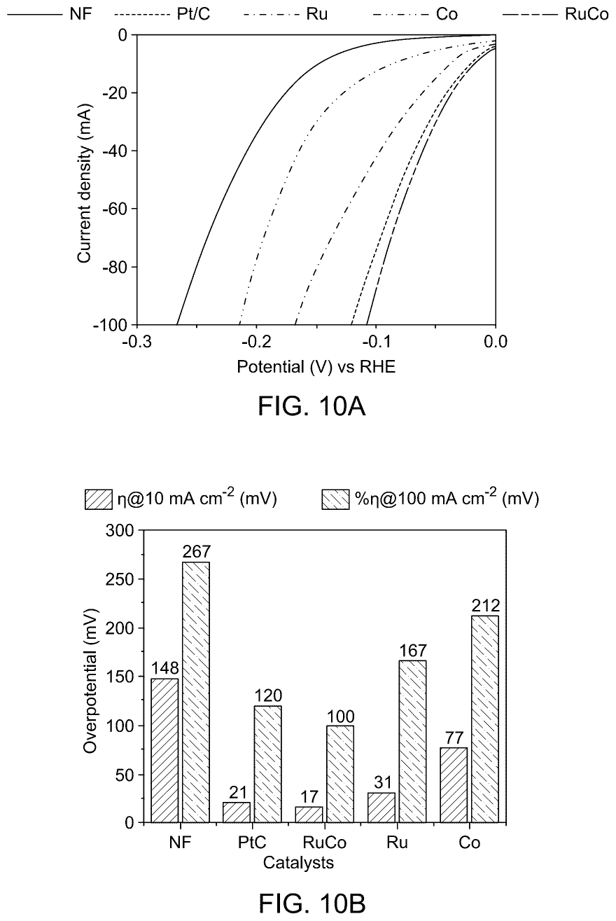

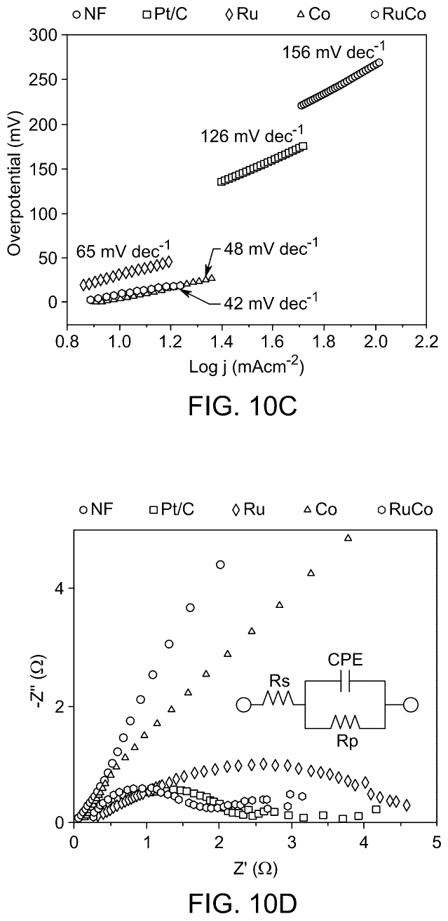

After CV experiments, the HER activity of as-synthesized catalysts was monitored by LSVs measurement at a low scan rate of 2 mVs⁻¹. The catalytic performance of commercial Pt/C and bare the NF were also measured for comparison. FIG. 10A depicts the LSV curves of the investigated catalysts. The bimetallic RuCo catalyst exhibited an enormous increase in current density even surpassing the benchmark Pt/C under the identical circumstance. As can be seen from FIG. 10B, the HER performance of all catalysts was evaluated by observing the over-potential (η) at benchmark 10 and 100 mAcm⁻². The trend was found to be the NF (148 and 267 mV)<the Co@NF (77 and 212 mV)<the Ru@NF (31 and 167 mV)<Pt/C (21 and 120 mV)<the RuCo@NF (17 and 100 mV). Besides, the η₁₀ of the RuCo (17 mV) catalyst is better than many high-profile HER catalysts such as Ru-MoO₂ nanocomposites (29 mV), PtCo NPs-Co nanowires/Ti mesh (28 mV), and Pd@Ru nanorods (30 mV) and PtCoRu NAs (22 mV) as described in more detailed in Table 1. The highest and superior performance of bimetallic RuCo may be ascribed to the synergistic cooperation developed between transition and noble metal on the porous and conductive NF surface under AACVD conditions.

TABLE 1
Comparison of the HER performance conducted in 1.0M KOH electrolyte
of the different Ru based electrocatalysts with recent studies.

| | | | η₁₀ | Tafel | |
|---|---|---|---|---|---|
| | | | mAcm⁻² | Slope | |
| Catalysts | Synthesis route | Substrate | (mV) | (mVdec⁻¹) | Reference |
| PtCoRu | Solvothermal | GCE | 22 | 46 | Chen, Hong-Yan, Hua-Jie |
| | | | | | Niu, Xiaohong Ma, Jiu-Ju |
| | | | | | Feng, Xuexiang Weng, Hong |
| | | | | | Huang, and Ai-Jun Wang. |
| | | | | | “Flower-like platinum- |
| | | | | | cobalt-ruthenium alloy |
| | | | | | nanoassemblies as robust |
| | | | | | and highly efficient |
| | | | | | electrocatalyst for hydrogen |
| | | | | | evolution reaction.” Journal |
| | | | | | of colloid and interface |
| | | | | | science 561 (2020): 372-378 |
| (Cu₅₃Ru₄₇)alloy | Dealloying | GCE | 15 | 30 | Wu, Qiuli, Min Luo, Jiuhui |
| | process | | | | Han, Wei Peng, Yang Zhao, |
| | | | | | Dechao Chen, Ming Peng, Ji |
| | | | | | Liu, Frank MF De Groot, |
| | | | | | and Yongwen Tan. |
| | | | | | “Identifying electrocatalytic |
| | | | | | sites of the nanoporous |
| | | | | | copper-ruthenium alloy for |
| | | | | | hydrogen evolution reaction |
| | | | | | in alkaline electrolyte.” ACS |
| | | | | | Energy Letters 5, no. 1 |
| | | | | | (2019): 192-199 |
| RuCo@HCS* | Wet vacuum | GCE | 21 | 32 | Wang, Haiyang, Caiyan |
| | impregnation | | | | Gao, Rui Li, Zhikun Peng, |
| | followed by | | | | Jinghe Yang, Jie Gao, |
| | pyrolysis | | | | Yongpeng Yang, Shuaihui |
| | | | | | Li, Baojun Li, and Zhongyi |
| | | | | | Liu. “Ruthenium-cobalt |
| | | | | | nanoalloy embedded within |
| | | | | | hollow carbon spheres as a |
| | | | | | bifunctionally robust catalyst |
| | | | | | for hydrogen generation |
| | | | | | from water splitting and |
| | | | | | ammonia borane |
| | | | | | hydrolysis.” ACS |
| | | | | | Sustainable Chemistry & |
| | | | | | Engineering 7, no. 23 |
| | | | | | (2019): 18744-18752 |
| RuCo@NC^{#} | In situ pyrolysis | GCE | 28 | 55 | Su, Jianwei, Yang Yang, |
| | method | | | | Guoliang Xia, Jitang Chen, |
| | | | | | Peng Jiang, and Qianwang |
| | | | | | Chen. “Ruthenium-cobalt |
| | | | | | nanoalloys encapsulated in |
| | | | | | nitrogen-doped graphene as |
| | | | | | active electrocatalysts for |
| | | | | | producing hydrogen in |
| | | | | | alkaline media.” Nature |
| | | | | | communications 8, no. 1 |
| | | | | | (2017): 14969 |
| Ru—CoMo/CFP^{$} | Electrodeposition | GCE | 44 | 47 | Lin, Y., Zhang, D., & Gong, |
| | | | | | Y. (2021). Ultralow |
| | | | | | ruthenium loading Cobalt- |
| | | | | | molybdenum binary alloy as |
| | | | | | highly efficient and super- |
| | | | | | stable electrocatalyst for |
| | | | | | water splitting. Applied |
| | | | | | Surface Science, 541, |
| | | | | | 148518 |
| Pd@Ru core- | Solvothermal | GCE | 30 | 45 | Luo, Yiqi, Xuan Luo, Geng |
| shell | | | | | Wu, Zhijun Li, Guanzhong |
| | | | | | Wang, Bin Jiang, Yanmin |
| | | | | | Hu et al. “Mesoporous Pd@ |
| | | | | | Ru core-shell nanorods for |
| | | | | | hydrogen evolution reaction |
| | | | | | in alkaline solution.” ACS |
| | | | | | applied materials & |
| | | | | | interfaces 10, no. 40 (2018): |
| | | | | | 34147-34152 |
| RuCo@NF | AACVD | Nickel | 17 | 42 | Present work |
| | | Foam | | | |

The catalytic character of an electrocatalyst may be described from the Tafel slope of the electrocatalyst, and a smaller slope normally signifies faster reaction kinetics of the electrocatalyst. To further explore the HER catalytic mechanism, Tafel slopes were extracted by plotting the η vs. the logarithm of the current density (j), as shown in FIG. 10C. Specifically, the Tafel slope for RuCo (42 mV dec⁻¹) is smaller than those of Pt/C (48 mV dec⁻¹), the Ru@NF (65 mV dec⁻¹), the Co@NF (126 mV dec⁻¹), and the NF (156 mV dec⁻¹) comparable or even better than those of the catalysts listed in above-mentioned Table 1. The catalysts with Tafel slope value in the range of 50-120 mVdec⁻¹ are reported to follow the Volmer-Heyrovsky mechanism.

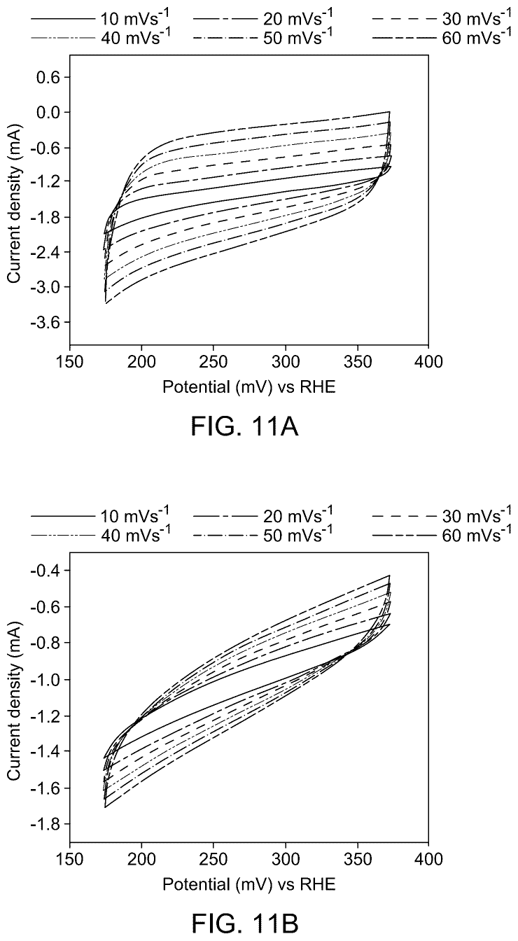

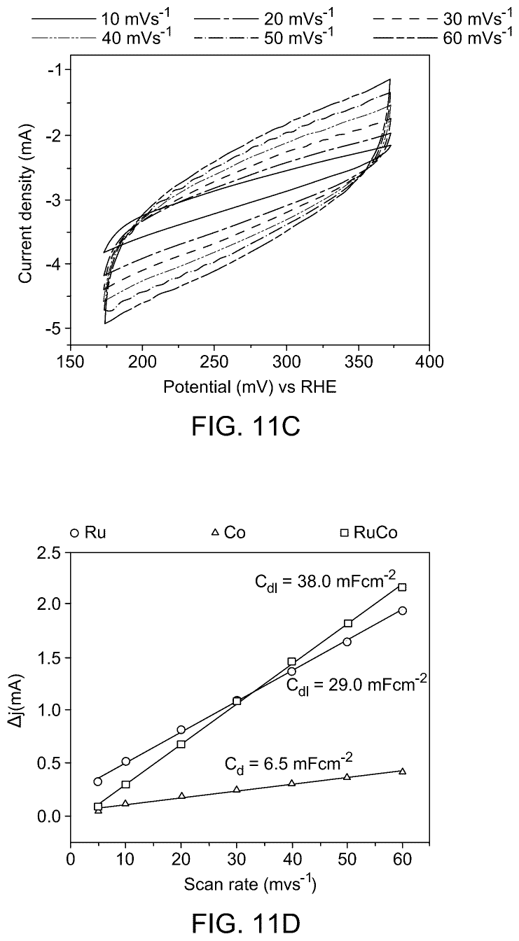

Further, electrochemical impedance spectroscopy (EIS) was used to compare the inherent conductive features of these catalysts that would directly influence their HER activity. As can be seen from FIG. 10D, the EIS Nyquist plots observe semicircles of different diameters, which denote different charge transfer resistances (R_{ct}) at the electrode interface. The inset of FIG. 10D shows the model circuit diagram used for fitting the EIS data. The RuCo@NF electrode displays the smallest R_{ct} value of (1.92 Ω) compared with Pt/C (2.28 Ω), the Ru@NF (5.32 Ω), the Co@NF (33.16 Ω) and the NF (47.89 Ω), indicating highest electron transfer capability of RuCo alloy among all investigated catalysts. The EIS results further confirm that metallic interaction between Ru and Co metals in alloy catalysts enhances the catalytic active sites to accelerate the charge and mass diffusion rates and benefit the improved HER efficiency. Moreover, the electrochemical active surface area (ECSA) was estimated to assess the intrinsic activity of these catalysts. The double layer capacitance (C_{dl}) of each catalyst was obtained from the corresponding CV curves measured in non-Faradic regions at different scan rates (10-60 mVs⁻¹). FIG. 11A-11C shows CVs obtained in the non-Faradaic region for the Co@NF electrode, Ru@NF, and RuCo@NF electrodes, respectively. The RuCo alloy delivers a higher Cdl of 38 mFcm⁻² than that of the Ru@NF (29 mFcm⁻²) and the Co@NF (6.5 mFcm⁻²). FIG. 11D is a graph showing current density versus scan rate curve, to measure double layer charge capacitance (C_{dl}) value of various electrodes. Mostly, the electrode with a higher C_{dl} value possesses more electrochemical active sites. Thus, the RuCo alloy is shown to have more accessible active sites constructed on its surface as compared to the other investigated catalysts.

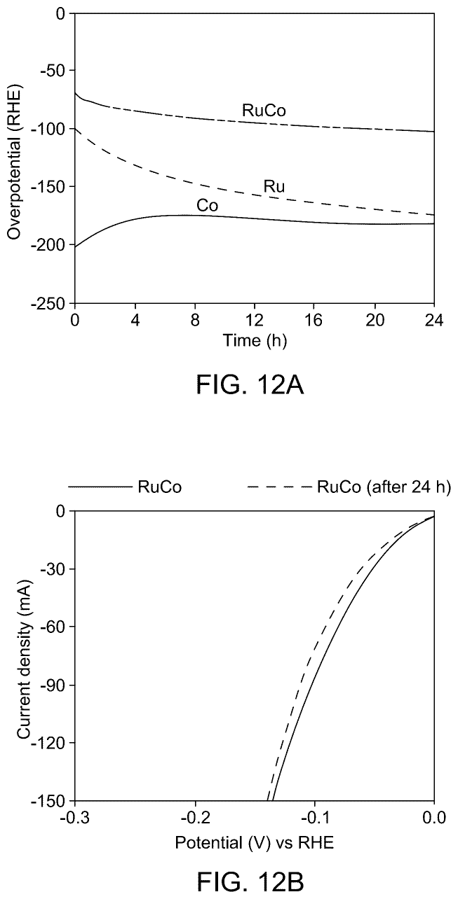

Apart from the excellent HER activity, the electrochemical durability is another significant parameter that decides the practical applicability of the electrocatalyst. Further, the chrono-potentiometric (CP) test was conducted at a fixed current density (50 mAcm⁻²) to evaluate the stability of all synthesized electrocatalysts, as shown in FIG. 12A. The pristine Co@NF exhibited a very high output potential (200 mV), while pristine Ru@NF showed relatively low-over potential (100 mV) but increased steadily over time, revealing inferior stability of metallic Ru. However, the bimetallic RuCo@NF demonstrated an almost stable and straight potential signal over the 24 h of the CP test, confirming the largely improved stability of the as-prepared RuCo alloy towards the HER. After the long-term durability test, the polarization curves of the RuCo@NF electrode exhibited a negligible shift in the onset potential, as indicated in FIG. 12B, manifesting the adequate durability of the as-prepared alloy catalysts in 1.0 M KOH solution. Overall, the HER activity of RuCo alloy is the result of electronic structure manipulation that occurred in Ru after alloying with transition metal Co.

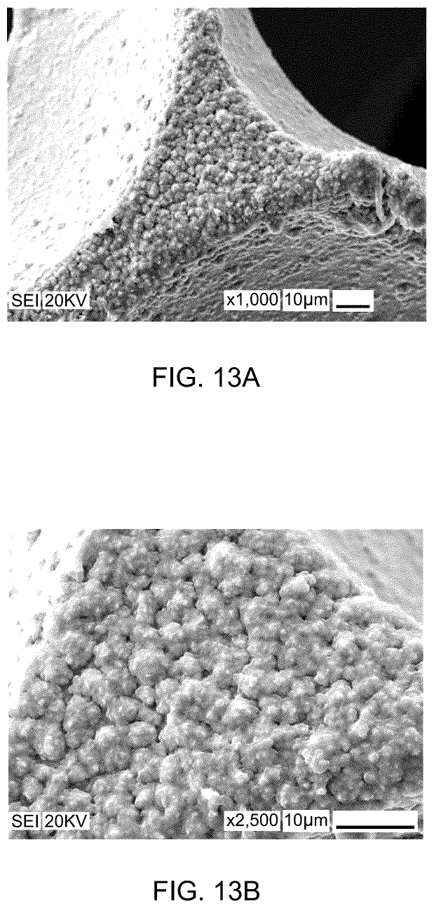

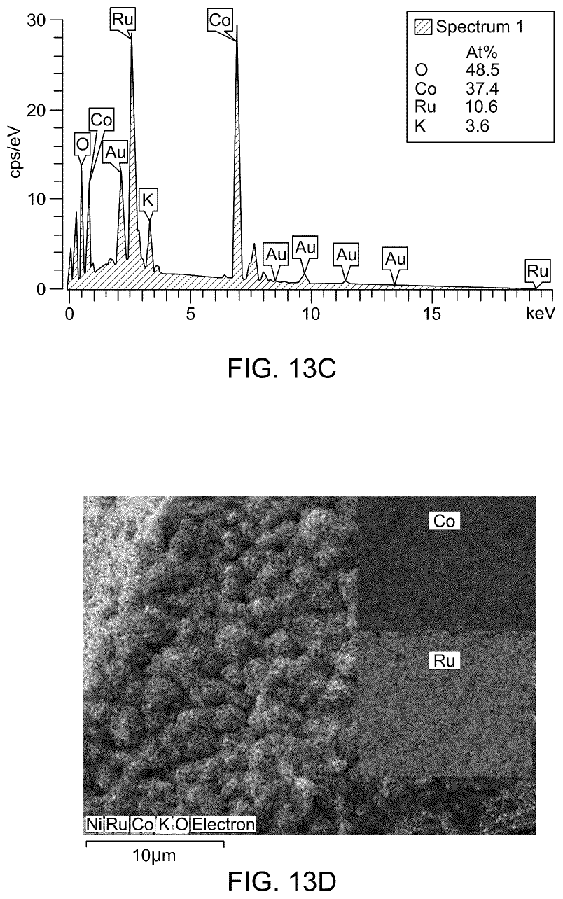

After the HER measurements, the surface of the RuCo@NF alloy catalyst was again characterized by SEM and EDX analysis, as depicted in FIGS. 13A-13D. A dense layer of spherical particles remained intact with the NF, as observed from SEM images shown in FIG. 13A and FIG. 13B. FIG. 13C is an EDX spectrum of the bimetallic RuCo alloy electrocatalyst after performing the HER process in a 1.0 M KOH electrolyte. The EDX analysis indicated a significant amount of Co and Ru atoms on the catalyst surface. Besides, strong peaks of potassium (K) and oxygen (O) were detected, which were incorporated from the KOH electrolyte. EDX map analysis showed that Ru and Co atoms maintained the elemental homogeneity, as shown in FIG. 13D. Thus, the AACVD-grown bimetallic RuCo electrocatalyst on nickel foam exhibited promising HER activity and durability.

To conclude, monometallic Ru, Co, and bimetallic RuCo alloy electrocatalysts were fabricated on nickel foam (NF) substrate through an AACVD route and were investigated for alkaline HER catalysis. The bimetallic Ru—Co alloy benefitted from the synergistic collaboration of Ru and Co metals, and unique nano-spherical morphology displayed excellent HER activity and stability in 1.0 M KOH electrolyte. The electrochemical characterization demonstrated that bimetallic the RuCo@NF possessed a low overpotential (17 mV at 10 mAcm⁻²), small Tafel slope (42 mVdec⁻¹), and long-term durability (24 h) with negligible loss in the activity.

Numerous modifications and variations of the present disclosure are possible in light of the above teachings. Therefore, it is to be understood that within the scope of the appended claims, the invention may be practiced other than as specifically described herein.

1. An electrode including a bimetallic ruthenium-cobalt (RuCo) alloy electrocatalyst, including:
a metallic substrate; and
a layer of a RuCo alloy at least partially covering a surface of the metallic substrate;
wherein the layer of the RuCo alloy includes spherical-shaped particles having an average particle size of 0.5 to 5 micrometers (μm).

2. The electrode of claim 1, wherein the spherical-shaped particles of the RuCo alloy have an average particle size of 1 to 3 μm.

3. The electrode of claim 1, wherein the spherical-shaped particles of the RuCo alloy are aggregated.

4. The electrode of claim 1, wherein the RuCo alloy includes 25 to 36 weight percentage (wt. %) of Ru, and 58 to 68 wt. % of Co, each wt. % based on a total weight of the RuCo alloy.

5. The electrode of claim 4, wherein the RuCo alloy includes 31.2 wt. % of Ru, and 63.4 wt. % of Co, each wt. % based on the total weight of the RuCo alloy.

6. The electrode of claim 1, wherein the metallic substrate is at least one metal foam selected from the group consisting of an aluminum foam, a nickel foam, a titanium foam, a titanium alloy foam, an aluminum alloy foam, a magnesium alloy foam, a nickel alloy foam, and a steel foam.

7. The electrode of claim 6, wherein the metallic substrate is a nickel foam.

8. The electrode of claim 1, having an overpotential of from 15 to 20 millivolts relative to the reversible hydrogen electrode (mV_{RHE}) at a current density of 10 milliamperes per square centimeter (mA/cm²).

9. The electrode of claim 1, having an overpotential of about 80 to 120 mV_{RHE} at a current density of about 100 mA/cm².

10. The electrode of claim 1, having an overpotential of 70 to 100 m V_{RHE} at a current density of 50 mA/cm² for at least 24 hours (h).

11. The electrode of claim 1, having a Tafel slope of 30 to 50 mV/decade.

12. The electrode of claim 1, having a charge transfer resistance (Rct) of 1.6 to 2.2 ohms (Ω) as determined by electrochemical impedance spectroscopy (EIS).

13. A method of making the electrode of claim 1, including:
mixing and dissolving a Ru salt, and a Co salt in a solvent to form a solution;
aerosolizing the solution to form an aerosol;
placing the metallic substrate in a heating chamber, and passing the aerosol through the heating chamber in the presence of a carrier gas;
wherein the metallic substrate is in direct contact with the aerosol;
heating the metallic substrate in the chamber at a temperature of about 450 to 500 degrees Celsius (° C.) to form the RuCo alloy on the surface of the metallic substrate; and
wherein at least a portion of the Ru salt and the Co salt present in the aerosol is decomposed to generate the RuCo alloy during the heating.

14. The method of claim 13, wherein the solvent is at least one selected from the group consisting of a ketone solvent, an ester solvent, an alcohol solvent, an amide solvent, and an ether solvent.

15. The method of claim 13, wherein a molar ratio of the Ru salt to the Co salt present in the solution is in a range of 1:1 to 1:4.

16. The method of claim 13, wherein the Co salt includes cobalt acetylacetonate, cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or its hydrate.

17. The method of claim 13, wherein the Ru salt includes ruthenium acetylacetonate, ruthenium sulfate, ruthenium acetate, ruthenium citrate, ruthenium iodide, ruthenium chloride, ruthenium perchlorate, ruthenium nitrate, ruthenium phosphate, ruthenium triflate, ruthenium bis(trifluoromethanesulfonyl)imide, ruthenium tetrafluoroborate, ruthenium bromide, and/or its hydrate.

18. The method of claim 13, wherein the aerosolizing is performed with an aerosol generator, and wherein the aerosol generator including:
a fluid chamber having a housing inlet, a housing outlet, and a vent;
a vibrating element operably coupled to the support plate for generating the aerosol;
wherein the solution is introduced into the fluid chamber via the housing inlet;
wherein the fluid chamber is in fluid communication with the heating chamber via the housing outlet; and
wherein the carrier gas is introduced into the fluid chamber via the vent, thereby carrying the aerosol into the heating chamber.

19. A method for electrochemical water splitting, including:
applying a potential between a counter and a working electrode in an electrochemical cell containing an electrolyte to form hydrogen and oxygen; and
separately collecting H₂-enriched gas and O₂-enriched gas.
wherein the working electrode includes the electrode of claim 1; and
wherein the electrolyte including an aqueous solution of a base at a concentration of 0.05 to 5 M.

20. The method of claim 19, wherein the base is at least one selected from the group consisting of NaOH, KOH, LiOH, Ba(OH)₂, and Ca(OH)₂.
